(19) United States
(12) Patent Application Publication
(10) Pub. No.: US 2024/0195741 A1
(43) Pub. Date: Jun. 13, 2024

(54) Segment Routing over Internet Protocol Version 6 (“IPv6”) Data Plane (“SRv6”) Replication Segment Identifier (SID) for use with Point to Multipoint (P2MP) Signaling Protocols Such as mLDP and RSVP-TE

(71) Applicant: Juniper Networks, Inc., Sunnyvale, CA (US)

(72) Inventor: Zhaohui Zhang, Westford, MA (US)

(73) Assignee: Juniper Networks, Inc., Sunnyvale, CA (US)

(21) Appl. No.: 18/534,080

(22) Filed: Dec. 8, 2023

Related U.S. Application Data
(60) Provisional application No. 63/431,605, filed on Dec. 9, 2022.

(51) Int. Cl. H04L 45/745; H04L 45/484; H04L 45/50

(52) U.S. Cl. CPC H04L 45/745; H04L 45/484; H04L 45/50

(57) ABSTRACT

A router on a multicast tree, may: (a) receive a control plane message (including a label and a tree identifier identifying the multicast tree) from a downstream router on the multicast tree; (b) construct an SRv6 SID in a LOC:FUNCT:ARG form, wherein the LOC part is a locator of the downstream router and the FUNCT part is the label included in the control plane message received; and (c) create an entry in its forwarding table so that the router replicates received traffic of this multicast tree to the downstream node using the SRv6 SID. A router on a multicast tree may construct an SRv6 SID in a LOC:FUNCT:ARG form for the multicast tree, wherein the LOC is a locator of the router and the FUNCT is to be signaled to an upstream router as a label.

### § 1. RELATED APPLICATION(S)

The present application claims priority to U.S. Provisional Application Ser. No. 63/431,605 (referred to as “the '605 application” and incorporated herein by reference), filed on Dec. 9, 2022, titled “SRv6 Replication SID for mLDP/RSVP-TE P2MP”, and listing Zhaohui Zhang as the inventor. The present application is not limited to any specific requirements or specific embodiments of the '605 application.

### § 2. BACKGROUND OF THE INVENTION

### § 2.1 Field of the Invention

The present application concerns network communications. In particular, the present application concerns Segment Routing over Internet Protocol Version 6 (“IPv6”) data plane (“SRv6”).

### § 2.2 Background Information

### § 2.2.1 Point-to-Multipoint (P2Mp)

A point-to-multipoint multiprotocol label switched (“MPLS”) label-switched path (“LSP”) is an LSP with a single source and multiple destinations. By taking advantage of the MPLS packet replication capability of the network, point-to-multipoint (“P2MP”) LSPs avoid unnecessary packet replication at the ingress router. Packet replication takes place only when packets are forwarded to two or more different destinations requiring different network paths.

A P2MP LSP includes tunnels from an ingress (or root) node to more than one egress (or leaf) nodes. A P2MP MPLS LSP is commonly set up (signaled) using the label distribution protocol (LDP) or using the resource reservation protocol (RSVP). For example, the document, J. Wijnands and I. Minei, Eds., “Label Distribution Protocol Extensions for Point-to-Multipoint and Multipoint-to-Multipoint Label Switched Paths,” Request for Comments: 6388 (Internet Engineering Task Force (IETF), November 2011)(referred to as “RFC 6388” and incorporated herein by reference) describes extensions to the Label Distribution Protocol (“LDP”) for the setup of point-to-multipoint (“P2MP”) and multipoint-to-multipoint (“MP2MP”) Label Switched Paths (“LSPs”) in MPLS networks. These extensions are also referred to as multipoint LDP (“mLDP”). Multipoint LDP constructs the P2MP or MP2MP LSPs without interacting with or relying upon any other multicast tree construction protocol. RFC 6388 describes protocol elements and procedures for building such LSPs in a receiver-initiated manner. As another example, the document, R. Aggarwal and D. Papadimitriou, Eds., “Extensions to Resource Reservation Protocol-Traffic Engineering (RSVP-TE) for Point-to-Multipoint TE Label Switched Paths (LSPs),” Request for Comments: 4875, (Internet Engineering Task Force, May 2007)(referred to as “RFC 4875” and incorporated herein by reference) describes extensions to Resource Reservation Protocol Traffic Engineering (“RSVP-TE”) for the set-up of Traffic Engineered (“TE”) P2MP LSPs in MPLS and Generalized MPLS (“GMPLS”) networks. The solution described in RFC 4875 relies on RSVP-TE without requiring a multicast routing protocol in the Service Provider core.

### § 2.2.2 SRv6

Segment Routing IPV6 (“SRv6”) is an IP protocol that combines Segment Routing (“SR”) and IPv6, leveraging existing IPv6 forwarding technology. SRv6 implements network programming through flexible IPv6 extension headers.

“Network programming” is the capability of a network to encode a network program into individual instructions. In SR-MPLS, these instructions are carried in MPLS labels where as in SRv6, these network instructions are carried natively in the IPV6 extension headers. These are called the SRv6 segment identifiers (“SIDs”) and are represented by a 128-bit IPv6 address. The IPv6 packet carrying the network instructions explicitly tells the network about the precise SRv6 nodes available for packet processing. The 128-bit SID can be used to convey a specific network programming instruction.

A SID represents a specific segment in a segment routing domain. In an IPV6 network, the SID-type used is a 128-bit IPv6 address, also referenced as an “SRv6 Segment” or “SRv6 SID.” An SRv6 SID consists of the following parts: (1) a locator part, (2) a function part, and (3) an argument part. The locator is the first part of a SID and consists of the most significant bits representing the address of a particular SRv6 node. The locator is very similar to a network address that provides a route to its parent node. The function part of the SID defines a function that is performed locally on the node identified by the locator.

The document, C. Filsfils and D. Dukes, Eds., “IPv6 Segment Routing Header (SRH),” Request for Comments: 8754 (Internet Engineering Task Force (IETF) March 2020) (referred to as “RFC 8754” and incorporated herein by reference), describes the Segment Routing Header (“SRH”) and how it is used by nodes that are Segment Routing (“SR”) capable. More specifically, Segment Routing can be applied to the IPV6 data plane using a new type of Routing Extension Header called the SRH. RFC 8754 describes an SRH including a Segment List which carries 128-bit IPv6 addresses (which may be used as IPv6 destination addresses).

The header which contains these SIDs is called the Segment Routing Extension Header (“SRH”). SRv6 stacks up these IPV6 addresses instead of MPLS labels in a segment routing extension header. Each time a SRv6 Node is visited, the SRH is processed based on the SID's Endpoint behavior in that SRv6 Node and the IPV6 destination address of the packet is updated with the next SID in the stack. This processing continues until the remaining segment becomes 0 and the SRH is decapsulated and the payload is exposed. After this point forwarding happens on the Payload destination address.

FIG. 1 illustrates an IPV6 packet 100 including an IPV6 header 110, extension headers 170, and a payload 190. As described in § 3 the document, S. Deering, et al, “Internet Protocol, Version 6 (IPv6) Specification,” Request for Comments: 8200 (Internet Engineering Task Force (IETF) July 2017) (referred to as “RFC 8200” and incorporated herein by reference), the IPv6 header 110 includes a 4-bit Version field 115 carrying an Internet Protocol version number (set to 6 for IPV6), an 8-bit Traffic Class field 120, a 20-bit Flow Label field 125, a 16-bit unsigned integer Payload Length field 130 (which specifies the length of the IPV6 payload, i.e., the rest of the packet following this IPv6 header, in octets, including any extension headers), an 8-bit Next Header field 135 (which carries the value of 43 for SR header type extension headers), an 8-bit unsigned integer Hop Limit field 140 (which is decremented by 1 by each node that forwards the packet, so that when forwarding, the packet 100 is discarded if value carried in the Hop Limit field 140 was zero when received or is decremented to zero, unless the node receiving the packet 100 is the destination of the packet 100), a 128-bit Source Address field 145 which carries the IPv6 address of the originator of the packet 100, and a 128-bit Destination Address field 150 which carries the IPV6 address of the intended recipient of the packet 100.

Still referring to FIG. 1, the example IPV6 packet 100 includes one or more extension headers 170; in this case, an “SR header” type extension header 175 and zero or more other extension header(s) 180. Section 4 of RFC 8200 specifies that in IPv6, optional internet-layer information is encoded in separate extension headers 170 that may be placed between the IPV6 header 110 and the upper-layer header in a packet. There are defined extension headers, each of which is identified by a distinct value in the Next Header field 135. When processing a sequence of Next Header values in a packet, the first one that is not an extension header [IANA-EH] indicates that the next item in the packet is the corresponding upper-layer header. A special “No Next Header” value is used if there is no upper-layer header.

The document C. Filsfils and P. Camarillo, Eds., “Segment Routing over IPv6 (SRv6) Network Programming,” Request for Comments: 8986 (Internet Engineering Task Force (IETF), February 2021) (referred to as “RFC 8986” and incorporated herein by reference) specifies the format of an element of a segment list. Referred to FIG. 2, an i^{th} segment list element, which may be an SRv6 SID used as an IPV6 destination address, 200 includes a locator 210, a function 220 and optional argument(s) 230. Per § 3.1 of RFC 8986, an SRv6 SID 200 is defined as consisting (essentially) of LOC:FUNCT:ARG, where a locator (LOC) 310 is encoded in the L most significant bits of the SID 200, followed by F bits of function (FUNCT) 220 and A bits of arguments (ARG) 230. The locator length (L) is flexible, and an operator is free to use the locator length of their choice. F and A may be any value as long as L+F+A<=128. When L+F+A is less than 128, then the remaining bits of the SRv6 SID 200 are zero.

A locator 210 may be represented as B:N where B is the SRv6 SID block (IPv6 prefix allocated for SRv6 SIDs by the operator) and N is the identifier of the parent node instantiating the SID. When the LOC part 210 of the SRv6 SID 200 is routable, it leads to the node, which instantiates the SID.

The function 220 is an opaque identification of a local behavior bound to the SID. The term “function” refers to the bit string in the SRv6 SID 200. The term “behavior” identifies the behavior bound to the SID 200.

The behavior of an SRv6 endpoint may require additional information for its processing (e.g., related to the flow or service). This information may be encoded in the ARG bits 230 of the SID 200. In such a case, the semantics and format of the ARG bits are defined as part of the SRv6 Endpoint behavior specification.

§ 2.2.3 the Desire to Transition from Sr Mpls to Srv6

In MPLS (See, e.g., “Multiprotocol Label Switching Architecture,” Request for Comments 3031 (Internet Engineering Task Force, January 2001)(incorporated herein by reference).) forwarding plane, Segment Routing Point-to-Multipoint (“SR P2MP”) (also known as “Tree SID”)(See, e.g., “Segment Routing Point-to-Multipoint Policy,” draft-ietf-pim-sr-p2mp—policy-05 (Internet Engineering Task Force, Jul. 2, 2022) (incorporated herein by reference).) is identical to mLDP and/or RSVP-TE P2MP (See, e.g., “Label Distribution Protocol Extensions for Point-to-Multipoint and Multipoint-to-Multipoint Label Switched Paths,” draft-ietf-mpls-ldp—p2mp-15 (Internet Engineering Task Force, Aug. 4, 2011)(incorporated herein by reference), and “Extensions to Resource Reservation Protocol-Traffic Engineering (RSVP-TE) for Point-to-Multipoint TE Label Switched Paths (LSPs),” Request for Comments: 4875 (Internet Engineering Task Force, May 2007) (incorporated herein by reference).) The present inventor(s) observes that are only two differences in the control plane: (1) controller based calculation and signaling; and (2) different control plane identifier (<tree-root, tree-id>vs. mLDP FEC or RSVP session)

When the controller calculation is not desired and/or not needed, SR-MPLS P2MP eliminates mLDP signaling, but still requires a controller. Many service providers are retaining mLDP even after they switch to SR-MPLS.

Consider a large multicast virtual private network (MVPN) deployment with provider edge-to-provider edge (“PE-PE”) mLDP tunnels, but in which only part of the mLDP domain is converted to SR. Even if one wants to eliminate mLDP signaling in that SR part, one still needs mLDP control plane for the rest of the network. Therefore, the draft “Controller Based BGP Multicast Signaling,” draft-ietf-bess-bgp-multicast-controller-09 (Internet Engineering Task Force, Apr. 11, 2022) (incorporated herein by reference) has an option of setting up a P2MP tunnel using BGP signaling, but with mLDP forwarding equivalency class (“FEC”).

There are network equipment customers who want to move to SRv6 and transition away from MPLS. Currently the only P2MP option is SRv6 Tree SID, but incremental, phased, transition from MPLS to SRv6 in the above example is cumbersome. Therefore, an improvement to help network operators transition from MPLS to SRv6 would be useful.

### § 3. SUMMARY OF THE INVENTION

Some example embodiments consistent with the present description provide a method for use by a router (a tree node) on a multicast tree the computer implemented method including: (a) receiving, by the router, a control plane message from a downstream router on the multicast tree, wherein the control plane message includes a label and a tree identifier identifying the multicast tree; (b) constructing, by the router, an SRv6 SID in a LOC:FUNCT:ARG form, wherein the LOC part is a locator of the downstream router and the FUNCT part is the label included in the control plane message received; and (c) creating an entry in a forwarding table of the router so that the router replicates received traffic of this multicast tree to the downstream node using the SRv6 SID. The entry of the forwarding table may also include an SRv6 SID of the router, whereby the entry maps the SRv6 SID of the router (e.g., as an IPV6 destination address) to the SRv6 SID constructed.

In some embodiments, the example method may further include: (d) receiving, by the router, a second control plane message from a second downstream router on the multicast tree, wherein the control plane message includes a second label and a tree identifier identifying the multicast tree; (e) constructing, by the router, a second SRv6 SID in the LOC:FUNCT:ARG form, wherein the LOC part is a locator of the second downstream router and the FUNCT part is the second label included in the second control plane message received; and (f) updating the entry in a forwarding table of the router so that the router replicates received traffic of this multicast tree to the downstream node using the both the SRv6 SID and the second SRv6 SID. The entry of the forwarding table may also include an SRv6 SID of the router, whereby the entry maps the SRv6 SID of the router (e.g., as an IPV6 destination address) to both the SRv6 SID constructed and the second SRv6 SID constructed.

In some example embodiments, the example method(s) may further include: (d) receiving traffic with the SRv6 SID of the router; and (e) replicating the received traffic using the entry, associated with the SRv6 SID of the router, in the forwarding table of the router. The traffic received may be an SRv6 packet (e.g., including the SRv6 SID in a destination address field of an IPv6 header).

In some example embodiments, the example method(s) may have previously provisioned the router to treat a signaled label as the FUNCT bits of an SRv6 SID instead of as a real MPLS label for MPLS data planes.

Some other example embodiments consistent with the present description provide a method for use by a router on a multicast tree, the computer implemented method including: (a) constructing, an SRv6 SID in a LOC:FUNCT:ARG form for the multicast tree, wherein the LOC is a locator of the router and the FUNCT is to be signaled to an upstream router as a label; (b) generating a control plane message including (1) the FUNCT part of the SRv6 SID as a label and (2) a tree identifier identifying the multicast tree; and (c) transmitting the control plane message generated to an upstream router on the multicast tree.

Some other example embodiments consistent with the present description provide a router comprising: (a) at least one processor; and (b) a storage system storing processor executable instructions which, when executed by the at least one processor, cause the at least one processor perform a multicast protocol method including (1) processing first label information in a first control plane message from a first downstream router as an MPLS label, and (2) processing second label information in a second control plane message from a second downstream router as FUNCTION bits of an SRv6 SID. In some such example routers, the multicast protocol method further includes (3) sending third label information in a third control plane message to a first upstream router that is configured to treat the third label information in the third control plane message as a label for MPLS traffic replication, and (4) sending fourth label information in a fourth control plane message to a second upstream router that is configured to treat the forth information in the fourth control plane message as part of an SRv6 SIC for SRv6 traffic replication. For example, the router and the first upstream router may belong to a first multicast tree, and the router and the second upstream router may belong to a second multicast tree.

### § 4. BRIEF DESCRIPTION OF THE DRAWINGS

FIG. 1 illustrates the data structure of an IPV6 packet with an SR header type header extension.

FIG. 2 illustrates the data structure of a segment list element (e.g., an SRv6 SID, the FUNCTION portion of which may be populated with a label).

FIG. 3 is a flow diagram of an example configuration and control plane signaling method consistent with the present application.

FIG. 4 is a flow diagram of a conventional SRv6 forwarding method, which may use FIB entries generated by the example method of claim 3.

FIGS. 5A-5E illustrate an example of operations of an example method consistent with the present application.

FIG. 6 illustrates two data forwarding systems, which may be used as nodes, coupled via communications links, in a communications network, such as communications network supporting SRv6.

FIG. 7 is a block diagram of a router which may be used a communications network, such as a communications network employing SRv6.

FIG. 8 is an example architecture in which ASICS may be distributed in a packet forwarding component to divide the responsibility of packet forwarding.

FIGS. 9A and 9B is an example of operations of the example architecture of FIG. 8.

FIG. 10 is a flow diagram of an example method for providing packet forwarding in an example router.

FIG. 11 is a block diagram of an exemplary machine that may perform one or more of the processes described, and/or store information used and/or generated by such processes.

### § 5. DETAILED DESCRIPTION

The present disclosure may involve novel methods, apparatus, message formats, and/or data structures for helping network operators to transition from MPLS to SRv6. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 5.1 Definitions and Acronyms

“FIB”: Forwarding Information Base.

“LDP”: Label Distribution Protocol.

“P2MP”: Point-to-Multipoint. Note that a P2MP tree may also be referred to as a “multicast tree”.

“RSVP”: Resource Reservation Protocol.

“SID”: Segment Identifier.

“SR”: Segment Routing.

“SRH”: IPv6 Segment Routing Header.

“Replication segment”: A segment in SR domain that replicates packets.

“Replication node”: A node in SR domain which replicates packets based on Replication segment.

“Downstream nodes”: A Replication segment replicates packets to a set of nodes. These nodes are Downstream nodes.

“Replication state”: State held for a Replication segment at a Replication node. It is conceptually a list of replication branches to Downstream nodes. The list can be empty.

“Replication SID”: Data plane identifier of a Replication segment. This is a SR-MPLS label or SRv6 Segment Identifier (SID).

“Point-to-Multipoint Service”: A service that has one ingress node and one or more egress nodes. A packet is delivered to all the egress nodes

“Root node”: An ingress node of a P2MP service.

“Leaf node”: An egress node of a P2MP service.

“Bud node”: A node that is both a Replication node and a Leaf node.

### § 5.2 Overview

A tunnel identified by mLDP FEC in the control plane can actually use SRv6 (See, e.g., “Segment Routing over IPv6 (SRv6) Network Programming,” Request for Comments: 8986 (Internet Engineering Task Force, February 2021)(incorporated herein by reference).) SID in the forwarding plane. Current SRv6 Replication SID is basically an MPLS label embedded in the FUNCTION bits of an IPV6 address, so one could easily implement the following:
SRv6 forwarding plane with traditional mLDP signaling (See, e.g., “Label Distribution Protocol Extensions for Point-to-Multipoint and Multipoint-to-Multipoint Label Switched Paths,” Request for Comments: 6388 (Internet Engineering Task Force, November 2011) (incorporated herein by reference).);
SRv6 forwarding plane with BGP (See, e.g., “A Border Gateway Protocol 4 (BGP-4),” Request for Comments: 4271 (Internet Engineering Task Force, January 2006)(incorporated herein by reference).) signaling with mLDP FEC; or
If desired, SRv6 forwarding plane with PCEP signaling (See, e.g., “Path Computation Element (PCE) Communication Protocol (PCEP),” Request for Comments: 5440 (Internet Engineering Task Force, March 2009)(incorporated herein by reference) with mLDP FEC.

An SR replication segment is a logical construct which connects a Replication Node to a set of Downstream Nodes. An SR replication segment is identified by <replication-id, node-id> in control plane.

With MPLS data plane, the forwarding state for a replication SID is identical to forwarding state on mLDP and/or RSVP P2MP tree nodes. That is, the Incoming label is mapped to (labeled) replication branches. With SRv6 data plane, the FUNCT bits in the LOC:FUNCT:ARG SID encoding are the equivalent of MPLS label. The LOC bits get the packet to local or downstream nodes.

A P2MP Tree may be set up as follows. An SR-P2MP replication tree is a concatenation of replication segments, which are installed on tree nodes, not encoded in packets. A controller signals individual replication segments onto tree nodes. This is the currently assumed approach, and uses BGP and/or PCEP signaling. Each replication segment is identified by a <replication-id, node-id> tuple in the control plane, wherein the replication-id is <tree-root, tree-id>.

Alternative control plane ID and signaling are now described. An existing MVPN deployment could be using traditional mLDP and/or RSVP P2MP signaling. Part of such an existing MVPN deployment may be transitioned to SR-P2MP (whether MPLS or SRv6 data plane). It may be desired to continue using mLDP FEC or RSVP Session even for the SR-P2MP part. There are three options for such control plane signaling. A first option is controller-signaled via BGP. This includes an mLDP option already specified in draft-ietf-bess-bgp-multicast-controller. A second option is controller-signaled via PCEP. A third option is traditional hop-by-hop mLDP and/or RSVP signaling for SRv6 data plane. This third option is useful when controller-based tree calculation/signaling is not needed/desired. This third option is further discussed below.

The option of signaling an SRv6 P2MP tree hop-by-hop (e.g., using mLDP, RSVP, etc.) is now discussed. Existing mLDP and/or RSVP protocol signals incoming and/or outgoing labels. However, an indication that the signaled label is actually the FUNCT bits of an SRv6 SID is needed. This indication can be provided (A) in the signaling itself (e.g., per branch or per sub-LSP), or (B) by provisioning. In the latter case, using provisioning to provide an indication that the signaled label is actually the FUNCT bits of an SRv6 SID may be done per-node, but consistent across the domain, and/or per-peer on border nodes to do MPLS-SRv6 interworking. In some example embodiments, a 20-bit FUNCT space could be carved out for mLDP and/or RSVP signaled SRv6 replication SIDs (if the FUNCT length of a SID encoding scheme is larger than 20). Some example implementations may support mLDP over RSVP as well.

### § 5.3 Example Method(s)

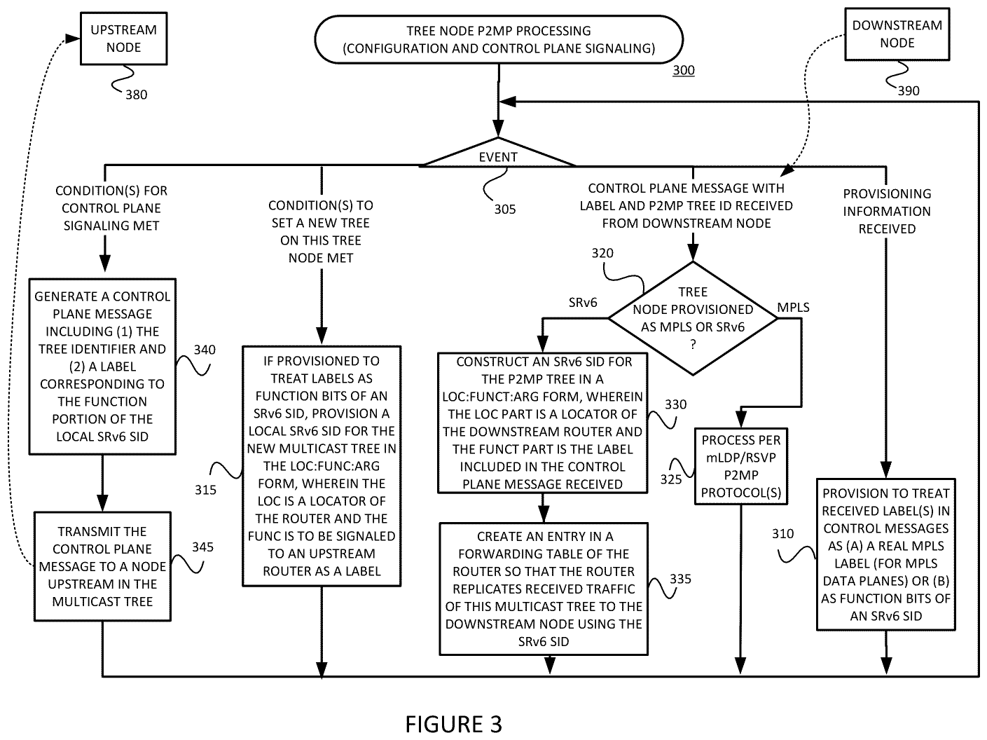

FIG. 3 illustrates a flow diagram of an example method 300 for performing P2MP (configuration and control plane signal) processing by a tree node in a manner consistent with the present application. As indicated by event branch point 305, different branches of the example method 300 are performed in response to the occurrence of different conditions or events.

Referring first to the right-most branch of the example method 300, responsive to the receipt of (e.g., one time) provisioning information, the example method 300 provisions the router to treat a signaled label as either (A) a real MPLS label for MPLS data planes, or (B) FUNCT bits of an SRv6 SID instead. (Block 310) In the following, it will be assumed that the tree node is provisioned to treat received labels as the FUNCT bits of an SRv6 SID instead of as a real MPLS label for MPLS data planes. Note, however, that the provisioning of block 310 may be performed on a per-neighbor level. Such per-neighbor provisioning could be very advantageous because it allows a router to be configured to treat labels from some downstream routers as labels while using labels from some other downstream routers to construct SRv6 SIDs (so that it replicates to some downstream routers using MPLS while it replicates to some others using SRv6). Similarly, some upstream routers may be configured to treat information in control plane signaling from the router as labels (for the router receive MPLS traffic and replicate) while other upstream routers may be configured to treat treat information in control plane signaling from the router as labels to be used to construct SRv6 SIDs (for the router to receive SRv6 traffic and replicate). The example method 300 may then return back to event branch point 305.

Referring next to the second left-most branch of the example method 300, responsive to condition(s) to set a new multicast tree on the node being met, the example method 300 may further provision, to the tree node, an SRv6 SID in a LOC:FUNCT:ARG form for the multicast tree, wherein the LOC is a locator of the router and the FUNCT is to be signaled to an upstream router as a label. (Block 315) The example method 300 may then return back to event branch point 305.

The second right-most branch of the example method 300 is performed responsive to receiving, by the tree node, a control plane message (that includes a label and a tree identifier identifying the multicast tree) from a downstream router 390 on the multicast tree. In response, the example method 300 determines whether or not the tree node is provisioned for MPLS or SRv6. (Decision 320) If, on the one hand, the tree node is provisioned for MPLS (Decision 320=MPLS), the example method 300 may process the control plane message per conventional (e.g., mLDP and/or RSVP) P2MP protocols. If, on the other hand, the tree node is provisioned for SRv6 (Decision 320=SRv6), the example method 300 constructs an SRv6 SID for the multicast tree in a LOC:FUNCT:ARG form, wherein the LOC part is a locator of the downstream router and the FUNCT part is the label included in the control plane message received (Block 330), and creates an entry in a forwarding table of the tree node so that the tree node replicates received traffic of this multicast tree to the downstream node using the SRv6 SID (Block 335). Referring to decision block 320, recall that the node may be provisioned on a per-neighbor basis. The example method 300 may then return back to event branch point 305.

In some example implementations of the example method 300, the control plane message received is an mLDP Label Mapping message for the mLDP P2MP tree, and the tree identifier is the mLDP FEC for the multicast tree. In other example implementations of the example method 300, the multicast tree is an RSVP P2MP tree, and the control plane message received is an RSVP Resv Message for the RSVP P2MP tree, and the tree identifier is the RSVP P2MP session object for the multicast tree.

The left-most branch of the example method 300 is performed responsive to condition(s) for control plane signaling being met. As one example, this condition may be met by the performance of block 315, described earlier. In this case, it is assumed that the tree node was provisioned for SRv6 P2MP (not SR MPLS P2MP). In response, the example method 300 generates a control plane message including (1) the FUNCT part of the SRv6 SID (Recall block 315) as a label and (2) a tree identifier identifying the multicast tree (Block 340), and transmits the control plane message generated to an upstream router 380 on the multicast tree (Block 345). In some example implementations of the example method 300, the multicast tree is an mLDP P2MP tree, and the control plane message is an mLDP Label Mapping message for the mLDP P2MP tree, and the tree identifier is the mLDP FEC for the multicast tree. In other example implementations of the example method 300, the multicast tree is an RSVP P2MP tree, and the control plane message is an RSVP Resv Message for the RSVP P2MP tree, and the tree identifier is the RSVP P2MP session object for the multicast tree. The example method 300 may then return back to event branch point 305.

Note that some or all of the branches of the example method 300 may be repeated. As one example, suppose that a second control plane message (which includes a second label and a tree identifier identifying the same multicast tree) from a second downstream router on the multicast tree is received. In response, the example method 300 may construct a second SRv6 SID in the LOC:FUNCT:ARG form, wherein the LOC part is a locator of the second downstream router and the FUNCT part is the second label included in the second control plane message received (Block 330), and update a previous entry for the multicast tree in the forwarding table of the tree node so that the tree node replicates received traffic of this multicast tree to the downstream node using the both the SRv6 SID received earlier, as well as the second SRv6 SID.

As should be appreciated from the foregoing description, example method 300 allows a tree node to transition from SR MPLS to SRv6 without changing existing P2MP control signal protocols, such as mLDP or RSVP-TE. For example, a local SRv6 SID (provisioned or constructed) may be mapped to SRv6 SID(s) associated with one or more downstream tree nodes.

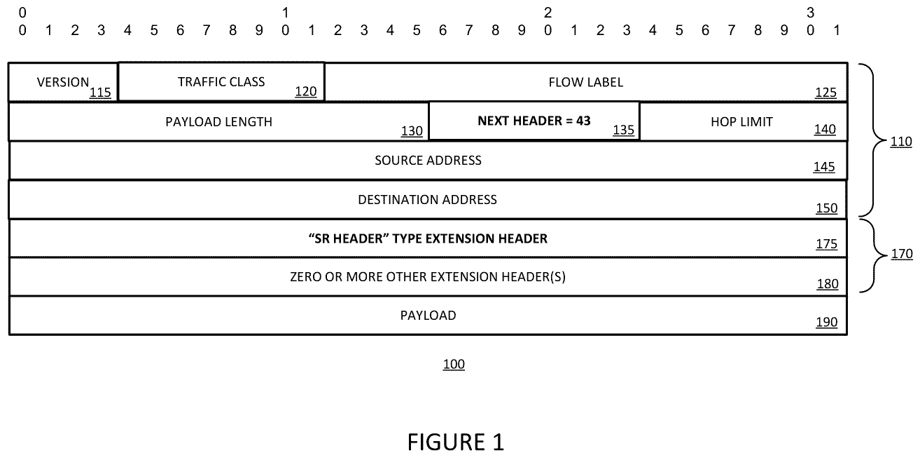

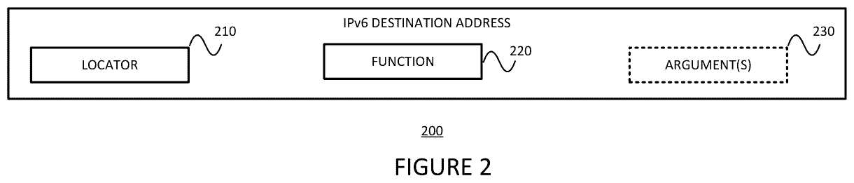

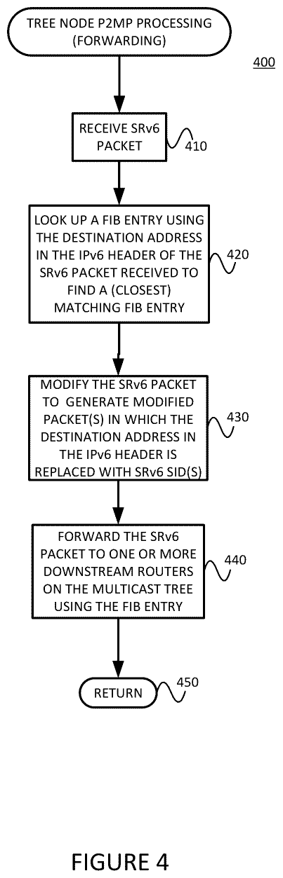

FIG. 4 is a flow diagram of conventional SRv6 forwarding method 400 which may use FIB entries generated by the example method 300 of claim 3. More specifically, the example method 400 receives, by the tree node, an SRv6 packet (that is, traffic with an SRv6 SID). (Block 410) In response, the example method 400 forwards (e.g., replicates) the received traffic using the entry, associated with the SRv6 SID, in the forwarding table of the tree node. More specifically, the example method 400 may look up a forwarding information base (FIB) entry using the destination address (Recall, e.g., 150 of FIG. 1.) in the IPV6 header (Recall, e.g., 110 of FIG. 1.) of the SRv6 packet (Recall, e.g., 100 of FIG. 1) received to find a closest matching entry. (Block 420) The example method 400 may then modify the SRv6 packet to generate modified packet(s) in which the destination address in the IPV6 header is replaced with SRv6 SID(s) from the FIB. (Block 430) (Note that forwarding at the leaf nodes of a multicast tree might be forwarded by using the SRv6 SID to find a closest matching entry in its local FIB and forward accordingly. That is, a leaf node could use the incoming IPV6 destination address (corresponding to the leaf node's SRv6 SID) to forward the packet using its local FIB.) Finally, the example method 400 may then forward the modified SRv6 packet(s) to one or more downstream nodes on the multicast tree. (Block 440) The example method 400 may then be left via return node 450.

In some cases of the example method 400, the traffic received is an SRv6 packet. In some such cases, the SRv6 packet includes the SRv6 SID in a destination address field (Recall 150 of FIG. 1.) of an IPV6 header (Recall, e.g., 110 of FIG. 1).

### § 5.4 Example of Operations of an Example Method

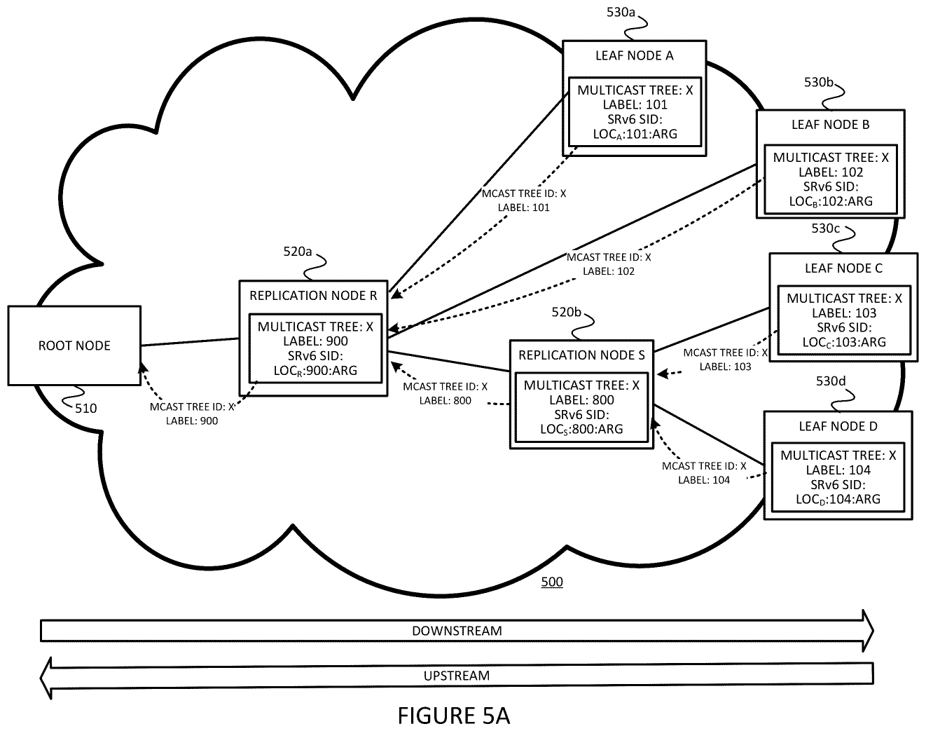

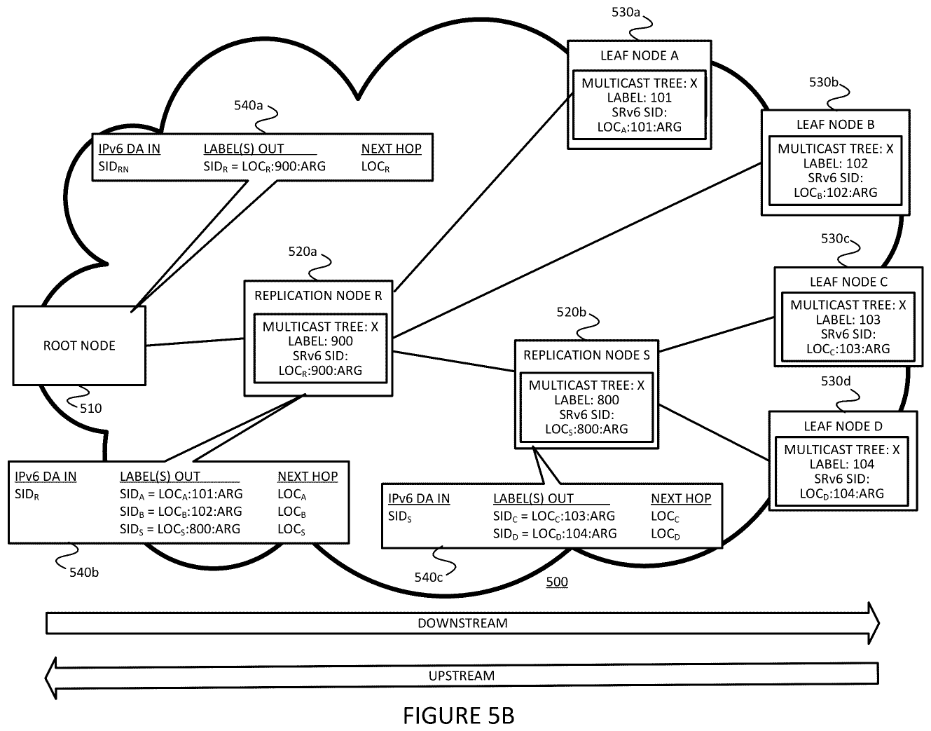

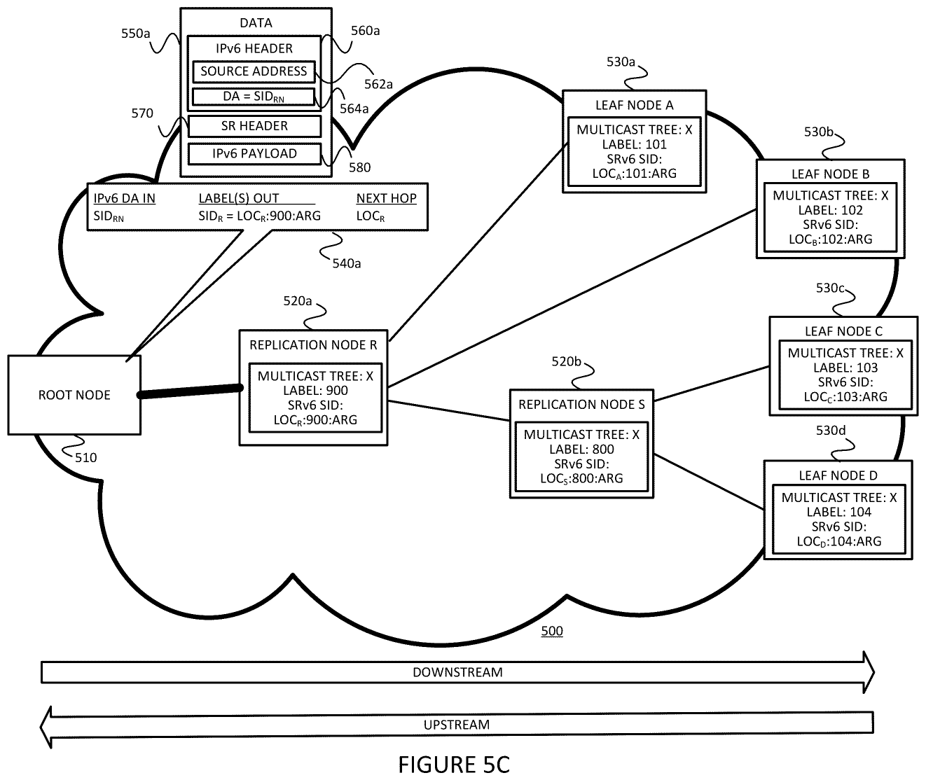

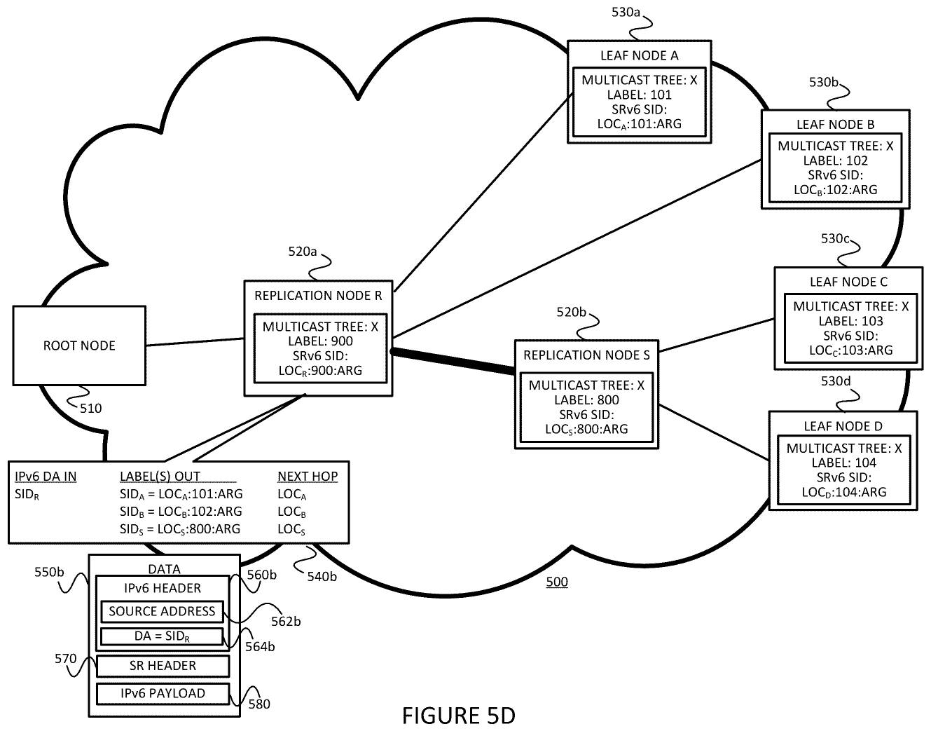

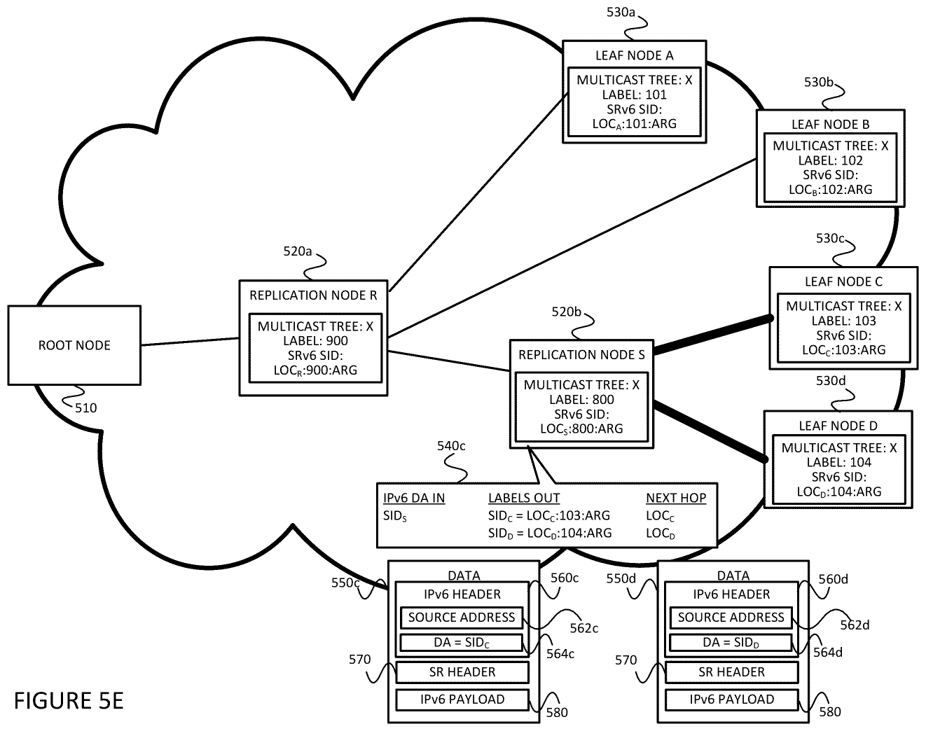

FIGS. 5A-5E illustrate an example of operations of the example method 400 in an example network environment 500 having a P2MP tree including a root node 510, replication nodes R 520a and S 520b, and leaf nodes A-D 530a-530d. This illustrative example uses a simplified multicast tree identifier (“X”) and simplified labels (“101”-“104”, “800” and “900”) to simplify explanation. There is a link from root node 510 to replication node R 520a, a link from replication node R 520a to each of leaf node A 530a, leaf node B 530b, and replication node S 520b, and a link from replication node S 520b to each of leaf node C 530c and leaf node D 530d. In FIGS. 5A-5E, left-to-right is defined as the downstream direction (i.e., from root node 510 to leaf nodes 530a-530d) and right-to-left is defined as the upstream direction (i.e., from leaf nodes 530a-530d to root node 510).

Referring first to FIG. 5A, leaf node A 530A belongs to multicast tree X and is configured with label 101, leaf node B 530B belongs to multicast tree X and is configured with label 102, leaf node C 530C belongs to multicast tree X and is configured with label 103, leaf node D 530D belongs to multicast tree X and is configured with label 104, replication node R 520a belongs to multicast tree X and is configured with label 900, and replication node S 520b belongs to multicast tree X and is configured with label 800. Assume that replication node R 520a and replication node S 520b are provisioned to treat received label(s) in control messages as function bits of an SRv6 SID. (Recall block 310 of FIG. 3.) Therefore, replication node R 520a is provisioned with an SRv6 SID consisting (essentially) of its LOCATOR (LOC_{R}):FUNCTION (label=900):ARG (empty), and replication node S 520b is provisioned with an SRv6 SID consisting (essentially) of its LOCATOR (LOC_{S}):FUNCTION (label=800):ARG (empty). Assume further that leaf nodes A-D 530a-530d are similarly provisioned to treat use label(s) as function bits of an SRv6 SID. (Recall block 310 of FIG. 3.) Therefore, leaf node A 530a is provisioned with an SRv6 SID consisting (essentially) of its LOCATOR (LOC_{A}):FUNCTION (label=101):ARG (empty), leaf node B 530b is provisioned with an SRv6 SID consisting (essentially) of its LOCATOR (LOC_{B}):FUNCTION (label=102):ARG (empty), leaf node C 530c is provisioned with an SRv6 SID consisting (essentially) of its LOCATOR (LOC_{C}):FUNCTION (label=103):ARG (empty), and leaf node D 530d is provisioned with an SRv6 SID consisting (essentially) of its LOCATOR (LOC_{D}):FUNCTION (label=104):ARG (empty).

Dotted arcs are used to illustrate hop-by-hop, upstream control plane signaling. Still referring to FIG. 5A, leaf node A 530a and leaf node B 530b advertise that they belong to multicast tree X and their respective labels (e.g., in an mLDP compliant message or an RSVP-TE compliant message) to replication node R 520a. Similarly, leaf node C 530c and leaf node D 530d advertise that they belong to multicast tree X and their respective labels (e.g., in an mLDP compliant message or an RSVP-TE compliant message) to replication node S 520b. Replication node S 520b advertises that it belongs to multicast tree X and its label (e.g., in an mLDP compliant message or an RSVP-TE compliant message) to replication node R 520a. Finally, replication node R 520a advertises that it belongs to multicast tree X and its label (e.g., in an mLDP compliant message or an RSVP-TE compliant message) to root node 510. (Recall, blocks 340 and 345 of FIG. 3.)

FIG. 5B illustrates the example network environment 500 with a portion of FIB entries in each of root node 510, replication node R 520a, and replication node S 520b. In each case the FIB entry includes a IPv6 Destination Address IN (corresponding to a SID label IN), label(s) OUT (corresponding to a list of one or more SIDs), and a next hop (corresponding to an IP address of the next downstream node in the multicast tree). Each FIB entry may include other information (e.g., OUT Interface, destination FEC, etc.), but such additional information is not shown for simplicity. As shown in FIG. 5B, replication node S has a FIB entry 540c in which an IPV6 destination address corresponding to its SID (SID_{S}) is associated with SID_{C} (LOC_{C}:103:ARG) and SID_{D} (LOC_{D}:104:ARG) as labels OUT, and LOC_{C} and LOC_{D} as next hops. Replication node R has a FIB entry 540b in which an IPV6 destination address corresponding to its SID (SID_{R}) is associated with SID_{A} (LOC_{A}:101:ARG), SID_{B} (LOC_{B}:102:ARG), and SID_{S} (LOC_{S}:800:ARG) as labels OUT, and LOC_{A}, LOC_{B} and LOC_{S} as next hops. Finally, root node 510 has a FIB entry 540a in which an IPV6 destination address corresponding to its SID (SID_{RN}) is associated with SID_{R} (LOC_{R}:900:ARG) as a label OUT, and LOC_{R} as a next hop. Although FIB entries in the leaf nodes A-D 530a-530d are not shown, the incoming IPv6 destination address (corresponding to the leaf node's SRv6 SID) would be used to look up the next hop.

At this time, the root node 510, replication node R 520a, and replication node S 520b are configured to forward packets over the multicast tree X. Forwarding a packet over the multicast tree X is now described with respect to FIGS. 5C-5E. In FIGS. 5C-5E, only the relevant FIB is shown.

Referring to FIG. 5C, assume that root node 510 receives packet 550a, which includes an IPV6 header 560a, an SR header extension 570, and a payload 580. The IPV6 header includes, among other things, a source address 562a and a destination address 564a. Note that the IPV6 destination address 564a is set to SID_{RN}. The root node 510 uses this DA SID to look up the FIB entry 540a having label(s) OUT=SID_{R} and next hop=LOC_{R}. The root node 510 will update the IPv6 destination address in the packet to SID_{R} before forwarding the updated packet to replication node R 520a.

Referring next to FIG. 5D, replication node R 520a receives packet 550b, which includes an IPV6 header 560b, an SR header extension 570, and a payload 580. The IPV6 header includes, among other things, a source address 562b and a destination address 564b. Note that the IPV6 destination address 564b is set to SID_{R}. The replication node R 520a uses this DA SID to look up the FIB entry 540b having label(s) OUT=SID_{A}, SID_{B}, and SID_{S} and next hops=LOC_{A}, LOC_{B}, and LOC_{S}, respectively. The replication node R 520a will replicate the packet and provide the packets with corresponding updated IPv6 destination addresses (SID_{A}, SID_{B}, and SID_{S}). For ease of illustration, only one of the three replicated packets is illustrated. The replicated packets are then sent to respective ones of leaf node A 530a, leaf node B 530b, and replication node S 520b.

Referring to FIG. 5E, replication node S 520b receives from replication node R 520a, the replicated packet (not shown). Note that the IPV6 destination address in the replicated packet was set to SID_{S}. The replication node S 520b uses this DA SID to look up the FIB entry 540c having label(s) OUT=SID_{C} and SID_{D} and next hops=LOC_{C} and LOC_{D}, respectively. The replication node S 520a will replicate the received packet and provide the packets 550c and 550d with corresponding updated IPv6 destination addresses (SID_{C} and SID_{D}). For ease of illustration, only processing by replication node S 520b is described. Although not illustrated, the leaf nodes A-D 530a-530d would use the incoming IPV6 destination address (corresponding to the leaf node's SRv6 SID) to forward the packet using its local FIB. The leaf nodes can use known or proprietary forwarding. As one example, using an Ultimate Segment Popping (USP) SRH mode, the leaf node terminates the last segment in the outer IPv6 header, removes the SRH and processes the inner service or control plane packet as indicated by the SRH Next-Header field.

As another example, using a Penultimate Segment Popping (PSP) SRH mode, the router that terminates the End or End. X segment before the last in the segment list, meaning the Segments-Left field before decrementing has a value of 1, removes the SRH on behalf of the leaf node.

### § 5.5 Example Apparatus

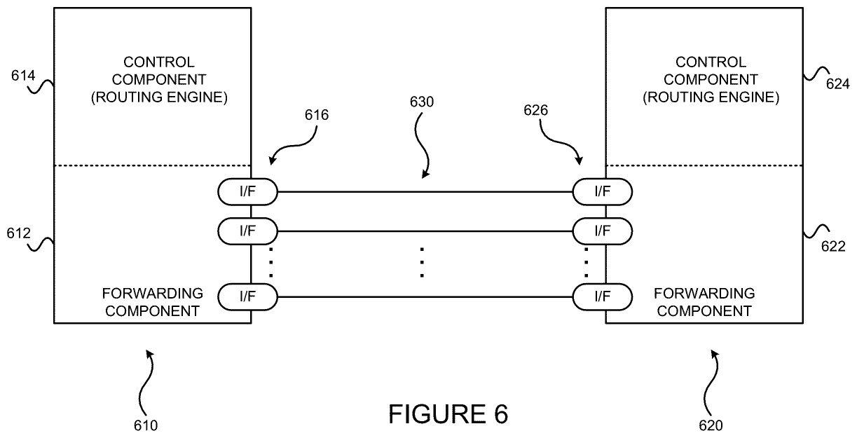

The data communications network nodes (including the root node, replication node(s), and leaf nodes) may be forwarding devices, such as routers for example. FIG. 6 illustrates two data forwarding systems 610 and 620 coupled via communications links 630. The links may be physical links or “wireless” links. The data forwarding systems 610,620 may be routers for example. If the data forwarding systems 610,620 are example routers, each may include a control component (e.g., a routing engine) 614,624 and a forwarding component 612,622. Each data forwarding system 610,620 includes one or more interfaces 616,626 that terminate one or more communications links 630.

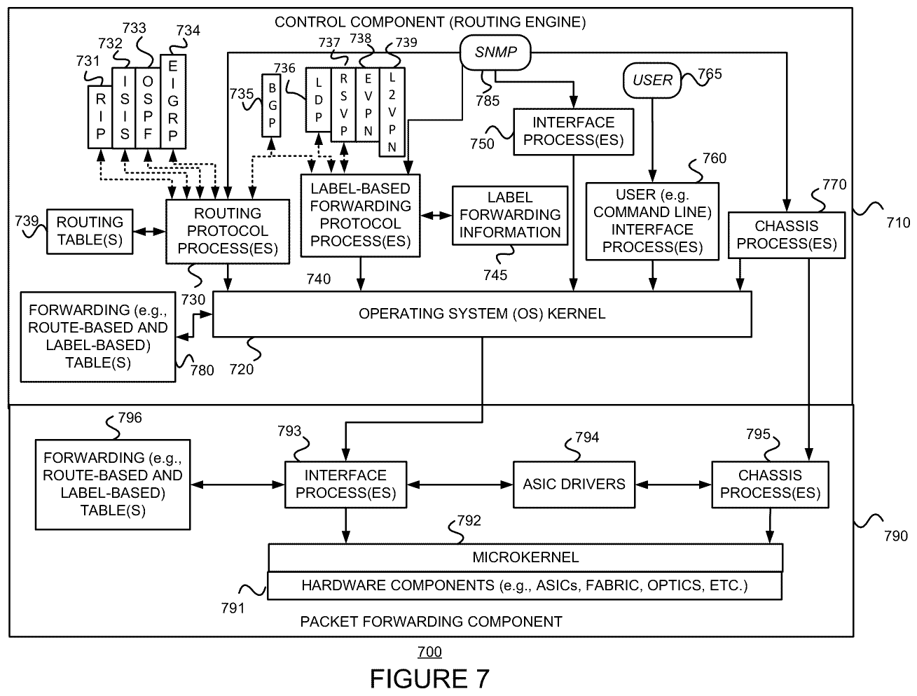

As just discussed above, and referring to FIG. 7, some example routers 700 include a control component (e.g., routing engine) 710 and a packet forwarding component (e.g., a packet forwarding engine) 790.

The control component 710 may include an operating system (OS) kernel 720, routing protocol process(es) 730, label-based forwarding protocol process(es) 740, interface process(es) 750, user interface (e.g., command line interface) process(es) 760, and chassis process(es) 770, and may store routing table(s) 739, label forwarding information 745, and forwarding (e.g., route-based and/or label-based) table(s) 780. As shown, the routing protocol process(es) 730 may support routing protocols such as the routing information protocol (“RIP”) 731, the intermediate system-to-intermediate system protocol (“IS-IS”) 732, the open shortest path first protocol (“OSPF”) 733, the enhanced interior gateway routing protocol (“EIGRP”) 734 and the border gateway protocol (“BGP”) 735, and the label-based forwarding protocol process(es) 740 may support protocols such as BGP 735, the label distribution protocol (“LDP”) 736, the resource reservation protocol (“RSVP”) 737, EVPN 738 and L2VPN 739. Other label-based forwarding protocols such as mLDP and RSVP-TE supporting P2MP may be included as well. One or more components (not shown) may permit a user 765 to interact with the user interface process(es) 760. Similarly, one or more components (not shown) may permit an outside device to interact with one or more of the router protocol process(es) 730, the label-based forwarding protocol process(es) 740, the interface process(es) 750, and the chassis process(es) 770, via SNMP 785, and such processes may send information to an outside device via SNMP 785.

The packet forwarding component 790 may include a microkernel 792 over hardware components (e.g., ASICs, switch fabric, optics, etc.) 791, interface process(es) 793, ASIC drivers 794, chassis process(es) 795 and forwarding (e.g., route-based and/or label-based) table(s) 796.

In the example router 700 of FIG. 7, the control component 710 handles tasks such as performing routing protocols, performing label-based forwarding protocols, control packet processing, etc., which frees the packet forwarding component 790 to forward received packets quickly. That is, received control packets (e.g., routing protocol packets and/or label-based forwarding protocol packets) are not fully processed on the packet forwarding component 790 itself, but are passed to the control component 710, thereby reducing the amount of work that the packet forwarding component 790 has to do and freeing it to process packets to be forwarded efficiently. Thus, the control component 710 is primarily responsible for running routing protocols and/or label-based forwarding protocols, maintaining the routing tables and/or label forwarding information, sending forwarding table updates to the packet forwarding component 790, and performing system management. The example control component 710 may handle routing protocol packets, provide a management interface, provide configuration management, perform accounting, and provide alarms. The processes 730, 740, 750, 760 and 770 may be modular, and may interact with the OS kernel 720. That is, nearly all of the processes communicate directly with the OS kernel 720. Using modular software that cleanly separates processes from each other isolates problems of a given process so that such problems do not impact other processes that may be running. Additionally, using modular software facilitates easier scaling.

Still referring to FIG. 7, the example OS kernel 720 may incorporate an application programming interface (“API”) system for external program calls and scripting capabilities. The control component 710 may be based on an Intel PCI platform running the OS from flash memory, with an alternate copy stored on the router's hard disk. The OS kernel 720 is layered on the Intel PCI platform and establishes communication between the Intel PCI platform and processes of the control component 710. The OS kernel 720 also ensures that the forwarding tables 796 in use by the packet forwarding component 790 are in sync with those 780 in the control component 710. Thus, in addition to providing the underlying infrastructure to control component 710 software processes, the OS kernel 720 also provides a link between the control component 710 and the packet forwarding component 790.

Referring to the routing protocol process(es) 730 of FIG. 7, this process(es) 730 provides routing and routing control functions within the platform. In this example, the RIP 731, ISIS 732, OSPF 733 and EIGRP 734 (and BGP 735) protocols are provided. Naturally, other routing protocols may be provided in addition, or alternatively. Similarly, the label-based forwarding protocol process(es) 740 provides label forwarding and label control functions. In this example, the LDP 736, RSVP 737, EVPN 738 and L2VPN 739 (and BGP 735) protocols are provided. Naturally, other label-based forwarding protocols (e.g., MPLS, SR, mLDP, RSVP-TE, SRv6, etc.) may be provided in addition, or alternatively. In the example router 700, the routing table(s) 739 is produced by the routing protocol process(es) 730, while the label forwarding information 745 is produced by the label-based forwarding protocol process(es) 740.

Still referring to FIG. 7, the interface process(es) 750 performs configuration of the physical interfaces and encapsulation.

The example control component 710 may provide several ways to manage the router. For example, it 710 may provide a user interface process(es) 760 which allows a system operator 765 to interact with the system through configuration, modifications, and monitoring. The SNMP 785 allows SNMP-capable systems to communicate with the router platform. This also allows the platform to provide necessary SNMP information to external agents. For example, the SNMP 785 may permit management of the system from a network management station running software, such as Hewlett-Packard's Network Node Manager (“HP-NNM”), through a framework, such as Hewlett-Packard's Open View. Accounting of packets (generally referred to as traffic statistics) may be performed by the control component 710, thereby avoiding slowing traffic forwarding by the packet forwarding component 790.

Although not shown, the example router 700 may provide for out-of-band management, RS-232 DB9 ports for serial console and remote management access, and tertiary storage using a removable PC card. Further, although not shown, a craft interface positioned on the front of the chassis provides an external view into the internal workings of the router. It can be used as a troubleshooting tool, a monitoring tool, or both. The craft interface may include LED indicators, alarm indicators, control component ports, and/or a display screen. Finally, the craft interface may provide interaction with a command line interface (“CLI”) 760 via a console port, an auxiliary port, and/or a management Ethernet port.

The packet forwarding component 790 is responsible for properly outputting received packets as quickly as possible. If there is no entry in the forwarding table for a given destination or a given label and the packet forwarding component 790 cannot perform forwarding by itself, it 790 may send the packets bound for that unknown destination off to the control component 710 for processing. The example packet forwarding component 790 is designed to perform Layer 2 and Layer 3 switching, route lookups, and rapid packet forwarding.

As shown in FIG. 7, the example packet forwarding component 790 has an embedded microkernel 792 over hardware components 791, interface process(es) 793, ASIC drivers 794, and chassis process(es) 795, and stores a forwarding (e.g., route-based and/or label-based) table(s) 796. The microkernel 792 interacts with the interface process(es) 793 and the chassis process(es) 795 to monitor and control these functions. The interface process(es) 792 has direct communication with the OS kernel 720 of the control component 710. This communication includes forwarding exception packets and control packets to the control component 710, receiving packets to be forwarded, receiving forwarding table updates, providing information about the health of the packet forwarding component 790 to the control component 710, and permitting configuration of the interfaces from the user interface (e.g., CLI) process(es) 760 of the control component 710. The stored forwarding table(s) 796 is static until a new one is received from the control component 710. The interface process(es) 793 uses the forwarding table(s) 796 to look up next-hop information. The interface process(es) 793 also has direct communication with the distributed ASICs. Finally, the chassis process(es) 795 may communicate directly with the microkernel 792 and with the ASIC drivers 794.

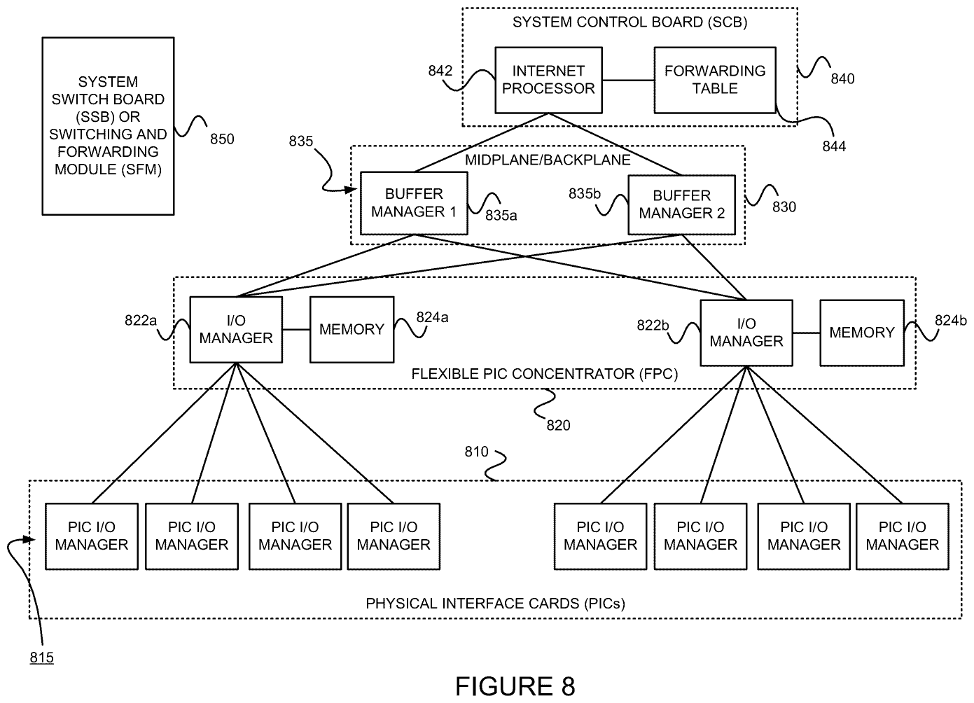

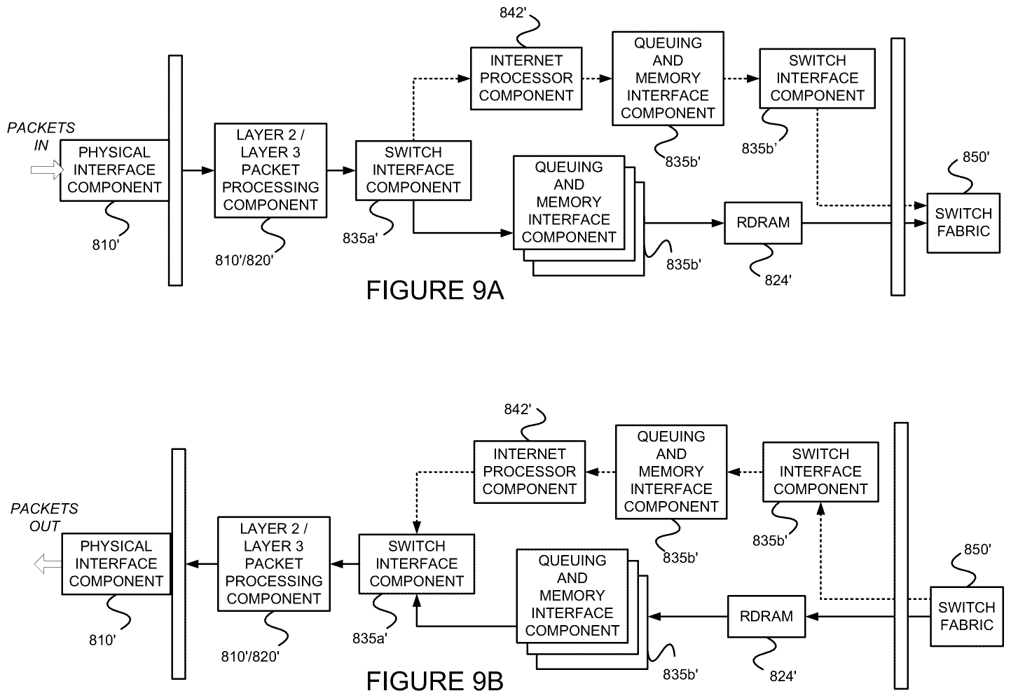

FIG. 8 is an example of how the ASICS may be distributed in the packet forwarding component 790 to divide the responsibility of packet forwarding. As shown in FIG. 8, the ASICs of the packet forwarding component 790 may be distributed on physical interface cards (“PICs”) 810, flexible PIC concentrators (“FPCs”) 820, a midplane or backplane 830, and a system control board(s) 840 (for switching and/or forwarding). Switching fabric is also shown as a system switch board (“SSB”), or a switching and forwarding module (“SFM”) 850 (which may be a switch fabric 850′ as shown in FIGS. 9A and 9B). Each of the PICs 810 includes one or more PIC I/O managers 815. Each of the FPCs 820 includes one or more I/O managers 822, each with an associated memory 824 (which may be a RDRAM 824′ as shown in FIGS. 9A and 9B). The midplane/backplane 830 includes buffer managers 835a, 835b. Finally, the system control board 840 includes an internet processor 842 and an instance of the forwarding table 844 (Recall, e.g., 796 of FIG. 7).

Still referring to FIG. 8, the PICs 810 contain the interface ports. Each PIC 810 may be plugged into an FPC 820. Each individual PIC 810 may contain an ASIC that handles media-specific functions, such as framing or encapsulation. Some example PICs 810 provide SDH/SONET, ATM, Gigabit Ethernet, Fast Ethernet, and/or DS3/E3 interface ports.

An FPC 820 can contain one or more PICs 810, and may carry the signals from the PICS 810 to the midplane/backplane 830 as shown in FIG. 8.

The midplane/backplane 830 holds the line cards. The line cards may connect into the midplane/backplane 830 when inserted into the example router's chassis from the front. The control component (e.g., routing engine) 710 may plug into the rear of the midplane/backplane 830 from the rear of the chassis. The midplane/backplane 830 may carry electrical (or optical) signals and power to each line card and to the control component 710.

The system control board 840 may perform forwarding lookup. It 840 may also communicate errors to the routing engine. Further, it 840 may also monitor the condition of the router based on information it receives from sensors. If an abnormal condition is detected, the system control board 840 may immediately notify the control component 710.

Referring to FIGS. 8, 9A and 9B, in some exemplary routers, each of the PICs 810,810′ contains at least one I/O manager ASIC 815 responsible for media-specific tasks, such as encapsulation. The packets pass through these I/O ASICs on their way into and out of the router. The I/O manager ASIC 815 on the PIC 810,810′ is responsible for managing the connection to the I/O manager ASIC 822 on the FPC 820,820′, managing link-layer framing and creating the bit stream, performing cyclical redundancy checks (CRCs), and detecting link-layer errors and generating alarms, when appropriate. The FPC 820 includes another I/O manager ASIC 822. This ASIC 822 (shown as a layer 2/layer 3 packet processing component 810′/820′) takes the packets from the PICs 810 and breaks them into (e.g., 74-byte) memory blocks. This FPC I/O manager ASIC 822 (shown as a layer 2/layer 3 packet processing component 810′/820′) sends the blocks to a first distributed buffer manager (DBM) 935a (shown as switch interface component 835a′), decoding encapsulation and protocol-specific information, counting packets and bytes for each logical circuit, verifying packet integrity, and applying class of service (CoS) rules to packets. At this point, the packet is first written to memory. More specifically, the example DBM ASIC 835/835a′ manages and writes packets to the shared memory 824 across all FPCs 820. In parallel, the first DBM ASIC 835/835a′ also extracts information on the destination of the packet and passes this forwarding-related information to the Internet processor 842/842′. The Internet processor 842/842′ performs the route lookup using the forwarding table 844 and sends the information over to a second DBM ASIC 835b′. The Internet processor ASIC 842/842′ also collects exception packets (i.e., those without a forwarding table entry) and sends them to the control component 710. The second DBM ASIC 825 (shown as a queuing and memory interface component 835b′) then takes this information and the 74-byte blocks and forwards them to the I/O manager ASIC 822 of the egress FPC 820/820′ (or multiple egress FPCs, in the case of multicast) for reassembly. (Thus, the DBM ASICs 835a/835a′ and 835b/835b′ are responsible for managing the packet memory 824/824′ distributed across all FPCs 820/820′, extracting forwarding-related information from packets, and instructing the FPC where to forward packets.)

The I/O manager ASIC 822 on the egress FPC 820/820′ may perform some value-added services. In addition to incrementing time to live (“TTL”) values and re-encapsulating the packet for handling by the PIC 810, it can also apply class-of-service (CoS) rules. To do this, it may queue a pointer to the packet in one of the available queues, each having a share of link bandwidth, before applying the rules to the packet. Queuing can be based on various rules. Thus, the I/O manager ASIC 822 on the egress FPC 820/820′ may be responsible for receiving the blocks from the second DBM ASIC 835/835′, incrementing TTL values, queuing a pointer to the packet, if necessary, before applying CoS rules, re-encapsulating the blocks, and sending the encapsulated packets to the PIC I/O manager ASIC 815.

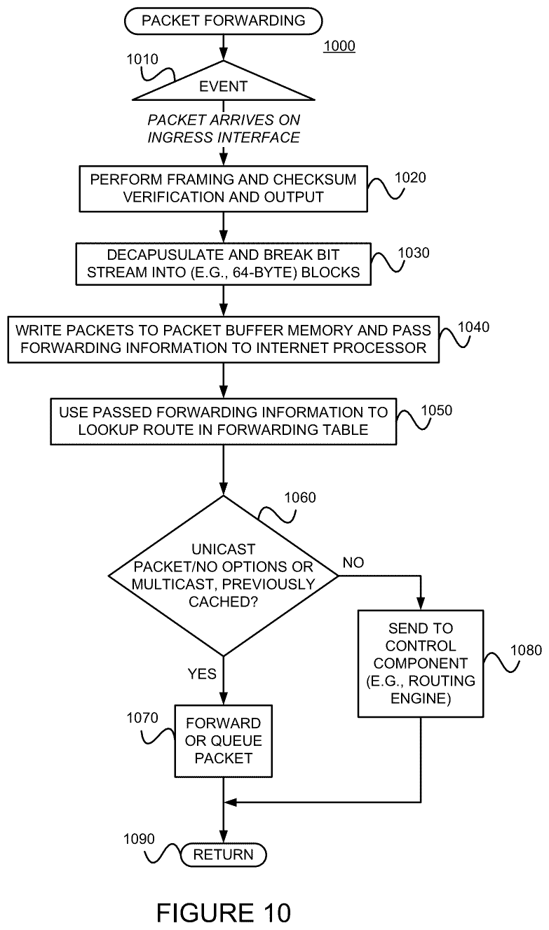

FIG. 10 is a flow diagram of an example method 1000 for providing packet forwarding in the example router. The main acts of the method 1000 are triggered when a packet is received on an ingress (incoming) port or interface. (Event 1010) The types of checksum and frame checks that are required by the type of medium it serves are performed and the packet is output, as a serial bit stream. (Block 1020) The packet is then decapsulated and parsed into (e.g., 64-byte) blocks. (Block 1030) The packets are written to buffer memory and the forwarding information is passed on the Internet processor. (Block 1040) The passed forwarding information is then used to lookup a route in the forwarding table. (Block 1050) Note that the forwarding table can typically handle unicast packets that do not have options (e.g., accounting) set, and multicast packets for which it already has a cached entry. Thus, if it is determined that these conditions are met (YES branch of Decision 1060), the packet forwarding component finds the next hop and egress interface, and the packet is forwarded (or queued for forwarding) to the next hop via the egress interface (Block 1070) before the method 1000 is left (Node 1090) Otherwise, if these conditions are not met (NO branch of Decision 1060), the forwarding information is sent to the control component 710 for advanced forwarding resolution (Block 1080) before the method 1000 is left (Node 1090).

Referring back to block 1070, the packet may be queued. Actually, as stated earlier with reference to FIG. 8, a pointer to the packet may be queued. The packet itself may remain in the shared memory. Thus, all queuing decisions and CoS rules may be applied in the absence of the actual packet. When the pointer for the packet reaches the front of the line, the I/O manager ASIC 822 may send a request for the packet to the second DBM ASIC 835b. The DBM ASIC 835 reads the blocks from shared memory and sends them to the I/O manager ASIC 822 on the FPC 820, which then serializes the bits and sends them to the media-specific ASIC of the egress interface. The I/O manager ASIC 815 on the egress PIC 810 may apply the physical-layer framing, perform the CRC, and send the bit stream out over the link.

Referring back to block 1080 of FIG. 10, as well as FIG. 8, regarding the transfer of control and exception packets, the system control board 840 handles nearly all exception packets. For example, the system control board 840 may pass exception packets to the control component 710.

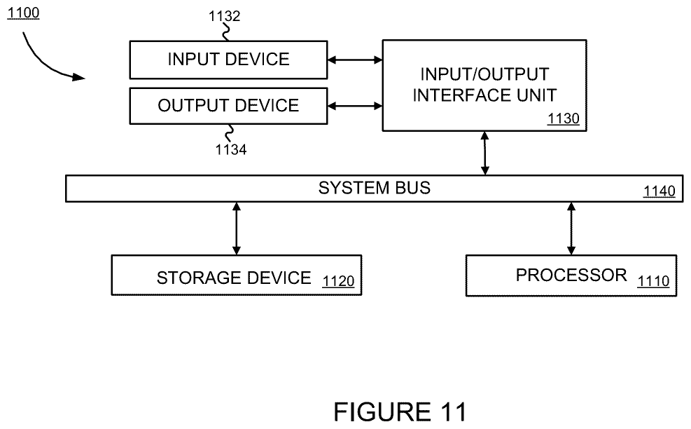

Although example embodiments consistent with the present description may be implemented on the example routers of FIG. 6 or 7, embodiments consistent with the present description may be implemented on communications network nodes (e.g., routers, switches, etc.) having different architectures. More generally, embodiments consistent with the present description may be implemented on an example system 1100 as illustrated on FIG. 11.

FIG. 11 is a block diagram of an exemplary machine 1100 that may perform one or more of the processes described, and/or store information used and/or generated by such processes. The exemplary machine 1100 includes one or more processors 1110, one or more input/output interface units 1130, one or more storage devices 1120, and one or more system buses and/or networks 1140 for facilitating the communication of information among the coupled elements. One or more input devices 1132 and one or more output devices 1134 may be coupled with the one or more input/output interfaces 1130. The one or more processors 1110 may execute machine-executable instructions (e.g., C or C++ running on the Linux operating system widely available from a number of vendors) to effect one or more aspects of the present description. At least a portion of the machine executable instructions may be stored (temporarily or more permanently) on the one or more storage devices 1120 and/or may be received from an external source via one or more input interface units 1130. The machine executable instructions may be stored as various software modules, each module performing one or more operations. Functional software modules are examples of components of the present description.

In some embodiments consistent with the present description, the processors 1110 may be one or more microprocessors and/or ASICs. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMS, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor. Such hardware and/or software might be provided in an addressed data (e.g., packet, cell, etc.) forwarding device (e.g., a switch, a router, etc.), a laptop computer, desktop computer, a tablet computer, a mobile phone, or any device that has computing and networking capabilities.

1: A computer-implemented method for use by a router on a multicast tree, the computer-implemented method comprising:
a) receiving, by the router, a control plane message from a downstream router on the multicast tree, wherein the control plane message includes a label and a tree identifier identifying the multicast tree;
b) constructing, by the router, an SRv6 SID in a LOC:FUNCT:ARG form, wherein the LOC part is a locator of the downstream router and the FUNCT part is the label included in the control plane message received; and
c) creating an entry in a forwarding table of the router so that the router replicates received traffic of this multicast tree to the downstream node using the SRv6 SID.

2: The computer-implemented method of claim 1, further comprising:
d) receiving, by the router, a second control plane message from a second downstream router on the multicast tree, wherein the control plane message includes a second label and a tree identifier identifying the multicast tree;
e) constructing, by the router, a second SRv6 SID in the LOC:FUNCT:ARG form, wherein the LOC part is a locator of the second downstream router and the FUNCT part is the second label included in the second control plane message received; and
f) updating the entry in a forwarding table of the router so that the router replicates received traffic of this multicast tree to the downstream node using the both the SRv6 SID and the second SRv6 SID.

3: The computer-implemented method of claim 1, further comprising:
provisioning the router to treat a signaled label as the FUNCT bits of an SRv6 SID instead of as a real MPLS label for MPLS data planes.

4-6. (canceled)

7: The computer-implemented method of claim 1, wherein the multicast tree is an mLDP P2MP tree, and
wherein the control plane message received is an mLDP Label Mapping message for the mLDP P2MP tree, and the tree identifier is the mLDP FEC for the multicast tree.

8: The computer-implemented method of claim 1, wherein the multicast tree is an RSVP P2MP tree, and
wherein the control plane message received is an RSVP Resv Message for the RSVP P2MP tree, and the tree identifier is the RSVP P2MP session object for the multicast tree.

9: A computer-implemented method for use by a router on a multicast tree, the computer-implemented method comprising:
a) constructing, an SRv6 SID in a LOC:FUNCT:ARG form for the multicast tree, wherein the LOC is a locator of the router and the FUNCT is to be signaled to an upstream router as a label;
b) generating a control plane message including (1) the FUNCT part of the SRv6 SID as a label and (2) a tree identifier identifying the multicast tree; and
c) transmitting the control plane message generated to an upstream router on the multicast tree.

10: The computer-implemented method of claim 9, wherein the multicast tree is an mLDP P2MP tree, and
wherein the control plane message received is an mLDP Label Mapping message for the mLDP P2MP tree, and the tree identifier is the mLDP FEC for the multicast tree.

11: The computer-implemented method of claim 9, wherein the multicast tree is an RSVP P2MP tree, and
wherein the control plane message received is an RSVP Resv Message for the RSVP P2MP tree, and the tree identifier is the RSVP P2MP session object for the multicast tree.

12: A computer-implemented method for use with a router, the computer-implemented method comprising:
a) processing first label information in a first control plane message from a first downstream router as an MPLS label; and
b) processing second label information in a second control plane message from a second downstream router as FUNCTION bits of an SRv6 SID.

13: The computer-implemented method of claim 12, further comprising:
c) sending third label information in a third control plane message to a first upstream router that is configured to treat the third label information in the third control plane message as a label for MPLS traffic replication, and
d) sending fourth label information in a fourth control plane message to a second upstream router that is configured to treat the fourth information in the fourth control plane message as part of an SRv6 SID for SRv6 traffic replication,
wherein the router and the first upstream router belong to a first multicast tree, and wherein the router and the second upstream router belong to a second multicast tree.
